(19) United States
(12) Patent Application Publication
(10) Pub. No.: US 2022/0153915 A1
(43) Pub. Date: May 19, 2022

(54) WATERBORNE POLYURETHANE DISPERSION AND METHOD FOR PREPARING SAME

(71) Applicant: Dow Global Technologies LLC, Midland, MI (US)

(72) Inventors: Yanli Feng, Shanghai (CN); Xiuyuan Ni, Shanghai (CN); Ming Bao, Shanghai (CN); Lingyun Pang, Shanghai (CN); Hongyu Chen, Shanghai (CN); Shaoguang Feng, Shanghai (CN)

(21) Appl. No.: 17/435,726

(22) PCT Filed: Apr. 10, 2020
(86) PCT No.: PCT/CN2020/084160

§ 371 Date: Sep. 2, 2021

(30) Foreign Application Priority Data
Mar. 15, 2019 (CN) PCT/CN2019/078233

(51) Int. Cl. C08G 18/61; C08G 18/75; C08G 18/34; C08G 18/65; C08G 18/12; C08G 18/08; C08L 75/04; C08J 5/18

(52) U.S. Cl. CPC C08G 18/61; C08G 18/755; C08G 18/348; C08G 18/6541; C08G 18/12; C08J 2475/04; C08L 75/04; C08J 5/18; C08L 2203/16; C08J 2375/04; C08G 18/0866

(57) ABSTRACT

A waterborne polyurethane dispersion is provided. The waterborne polyurethane dispersion comprises residual moiety of a hydroxy-terminated siloxane compound in the main chain and exhibits good anti-stickiness and/or wet color fastness while retaining superior mechanical properties. A laminated synthetic leather article prepared with said waterborne polyurethane dispersion as well the method for preparing the synthetic leather article are also provided.

### FIELD OF THE INVENTION

The present disclosure relates to a waterborne polyurethane dispersion and a method for preparing the same, a laminated synthetic leather article comprising a skin film derived from the waterborne polyurethane dispersion and a method for preparing the same. The laminated synthetic leather article prepared by said waterborne polyurethane dispersion exhibits superior anti-stickiness, mechanical properties and/or wet color fastness.

### INTRODUCTION

Synthetic leather gets popular applications in people's daily life, from clothes, footwear, bag and luggage, home upholstery to seats in automobile. It provides similar performance and hand feeling to natural leather with much better cost advantage. Synthetic leather is fabricated by coating polymer(s) on a fabric substrate or impregnating polymer(s) into a fabric substrate, and the most commonly used polymer is polyurethane (PU). Currently, most of the PU leathers are made from solvent based PU, but vaporization of the solvent during processing and residual in the leather creates issues for the environment and worker's health. Due to pressure from the governments and regulations, the industry roadmap indicates that environmentally friendly PU leather is required and will grow very fast. Waterborne polyurethane dispersion (PUD) will take more and more important role as skin layer for synthetic leather application as one of the environmentally friendly solutions in the market. Nevertheless, it has been reported that the synthetic leather manufactured by using the waterborne polyurethane dispersion had many problems, such as stickiness. Non-stickiness is a very critical performance for the PUD skin layer and lots of innovation efforts were made to improve this property. It has been reported that some additives such as fillers or hand feeling additives can be used for improving the stickiness of the PUD skin layer, but there still remains a constant demand for a solvent-free PUD exhibiting superior stickiness and/or wet color fastness while retaining the maintaining good PUD film mechanical properties comparable to those of the solvent-borne PUD.

After persistent exploration, we have surprisingly found a waterborne polyurethane dispersion which can achieve one or more of the above targets.

### SUMMARY OF THE INVENTION

The present disclosure provides a unique waterborne polyurethane dispersion and a laminated synthetic leather article prepared by using the same.

In a first aspect of the present disclosure, the present disclosure provides a waterborne polyurethane dispersion comprising polyurethane particles dispersed in water, wherein the waterborne polyurethane dispersion is derived from:

(A) an isocyanate component comprising one or more compounds having at least two isocyanate groups;

(B) an isocyanate-reactive component comprising one or more compounds having at least two isocyanate-reactive groups;

(C) a hydroxy-terminated siloxane compound represented by Formula I:

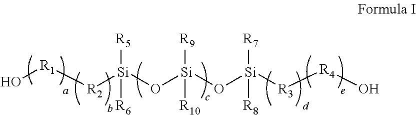

wherein each of R₁ and R₄ independently represents a methylene optionally substituted with one or two substituents selected from the group consisting of C₁-C₅ alkyl, C₁-C₅ alkoxy, C₆-C₁₂ aryl, C₆-C₁₂ aryloxy and halogen;

each of R₂ and R₃ independently represents a C₁-C₆ alkylene oxide group optionally substituted with one or more substituents selected from the group consisting of C₁-C₅ alkyl, C₁-C₅ alkoxy, C₆-C₁₂ aryl, C₆-C₁₂ aryloxy and halogen;

each of R₅, R₆, R₇, R₈, R₉ and R₁₀ independently represents a C₁-C₅ alkyl optionally substituted with one or more substituents selected from the group consisting of C₁-C₅ alkyl, C₁-C₅ alkoxy, C₆-C₁₂ aryl, C₆-C₁₂ aryloxy and halogen;

wherein each of a and e is independently an integer of 0 to 30; each of b and d is independently an integer of 5 to 30; and c is an integer of 3 to 100; or

each of a and e is independently an integer of 1 to 30; each of b and d is independently an integer of 0; and c is an integer of 3 to 100;

(D) a catalyst;

(E) an emulsifier;

(F) a chain extender; and

(G) water.

In a second aspect of the present disclosure, the present disclosure provides a method for producing the waterborne polyurethane dispersion of the first aspect, comprising (i) reacting the isocyanate component (A) with the isocyanate-reactive component (B) and the hydroxy-terminated siloxane compound (C) in the presence of the catalyst (D) to form first prepolymerized intermediates; (ii) reacting the first prepolymerized intermediates with the emulsifier (E) to form an second prepolymerized intermediate; (iii) reacting the prepolymerized intermediate with the chain extender (F) to form the waterborne polyurethane dispersion. Preferably, the second prepolymerized intermediate formed in step (ii) is neutralized with a neutralization agent before reacting with the chain extender (F) in step (iii).

In a third aspect of the present disclosure, the present disclosure provides a synthetic leather article, comprising, from top to bottom: a polyurethane skin film derived from the waterborne polyurethane dispersion of the first aspect; a base layer derived from a 2k PU composite composition; and an optional backing substrate.

In a fourth aspect of the present disclosure, the present disclosure provides a method for preparing the synthetic leather article of the third aspect, comprising:

a) providing the waterborne polyurethane dispersion of the first aspect;

b) forming the polyurethane skin film with the waterborne polyurethane dispersion;

c) applying the 2k PU composite composition onto one side of the polyurethane skin film to form the base layer; and

d) optionally, applying the backing substrate onto one side of the base layer opposite the polyurethane skin film.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic illustration of a cross-section of one embodiment of a synthetic leather article described herein;

FIG. 2 is a schematic illustration of a process for preparing a synthetic leather article described herein;

FIG. 3 shows the TEM photomicrographs of five PUDs prepared in Examples 1-5; and

FIG. 4 shows the photomicrographs of five synthetic leathers after the anti-stickiness test.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, the term “composition”, “formulation” or “mixture” refers to a physical blend of different components, which is obtained by mixing simply different components by a physical means.

As disclosed herein, “and/or” means “and, or as an alternative”. All ranges include endpoints unless otherwise indicated.

The Isocyanate Component

In various embodiments, the isocyanate component (A) has an average functionality of at least about 2.0, preferably from about 2 to 10, more preferably from about 2 to about 8, and most preferably from about 2 to about 6. In some embodiments, the isocyanate component includes one or more polyisocyanate compound comprising at least two isocyanate groups. Suitable polyisocyanate compounds include aromatic, aliphatic, cycloaliphatic and araliphatic polyisocyanates having two or more isocyanate groups. In a preferable embodiment, the polyisocyanate component comprises polyisocyanate compounds selected from the group consisting of C₄-C₁₂ aliphatic polyisocyanates comprising at least two isocyanate groups, C₆-C₁₅ cycloaliphatic or aromatic polyisocyanates comprising at least two isocyanate groups, C₇-C₁₅ araliphatic polyisocyanates comprising at least two isocyanate groups, and combinations thereof. In another preferable embodiment, suitable polyisocyanate compounds include m-phenylene diisocyanate, 2,4-toluene diisocyanate and/or 2,6-toluene diisocyanate (TDI), the various isomers of diphenylmethanediisocyanate (MDI), carbodiimide modified MDI products, hexamethylene-1,6-diisocyanate, tetramethylene-1,4-diisocyanate, cyclohexane-1,4-diisocyanate, hexahydrotoluene diisocyanate, hydrogenated MDI, naphthylene-1,5-diisocyanate, isophorone diisocyanate (IPDI), or mixtures thereof.

Alternatively or additionally, the polyisocyanate component may also comprise a isocyanate prepolymer having an isocyanate functionality in the range of 2 to 10, preferably from 2 to 8, more preferably from 2 to 6. The isocyanate prepolymer can be obtained by reacting the above stated monomeric isocyanate components with one or more isocyanate-reactive compounds selected from the group consisting of ethylene glycol, 1,2-propanediol, 1,3-propanediol, 1,3-butanediol, 1,4-butenediol, 1,4-butynediol, 1,5-pentanediol, neopentyl-glycol, bis(hydroxy-methyl) cyclohexanes such as 1,4-bis(hydroxymethyl)cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol and polybutylene glycols. Suitable prepolymers for use as the polyisocyanate component are prepolymers having NCO group contents of from 2 to 40 weight percent, more preferably from 4 to 30 weight percent. These prepolymers are preferably prepared by reaction of the di- and/or poly-isocyanates with materials including lower molecular weight diols and triols. Individual examples are aromatic polyisocyanates containing urethane groups, preferably having NCO contents of from 5 to 40 weight percent, more preferably 20 to 35 weight percent, obtained by reaction of diisocyanates and/or polyisocyanates with, for example, lower molecular weight diols, triols, oxyalkylene glycols, dioxyalkylene glycols, or polyoxyalkylene glycols having molecular weights up to about 800. These polyols can be employed individually or in mixtures as di- and/or polyoxyalkylene glycols. For example, diethylene glycols, dipropylene glycols, polyoxyethylene glycols, ethylene glycols, propylene glycols, butylene glycols, polyoxypropylene glycols and polyoxypropylene-polyoxyethylene glycols can be used. Polyester polyols can also be used, as well as alkane diols such as butane diol. Other diols also useful include bishydroxyethyl- or bishydroxypropyl-bisphenol A, cyclohexane dimethanol, and bishydroxyethyl hydroquinone.

Also advantageously used for the isocyanate component are the so-called modified multifunctional isocyanates, that is, products which are obtained through chemical reactions of the above isocyanates compounds. Exemplary are polyisocyanates containing esters, ureas, biurets, allophanates and preferably carbodiimides and/or uretoneimines. Liquid polyisocyanates containing carbodiimide groups, uretoneimines groups and/or isocyanurate rings, having isocyanate groups (NCO) contents of from 12 to 40 weight percent, more preferably from 20 to 35 weight percent, can also be used. These include, for example, polyisocyanates based on 4,4′-2,4′- and/or 2,2′-diphenylmethane diisocyanate and the corresponding isomeric mixtures, 2,4- and/or 2,6-toluenediisocyanate and the corresponding isomeric mixtures; mixtures of diphenylmethane diisocyanates and PMDI; and mixtures of toluene diisocyanates and PMDI and/or diphenylmethane diisocyanates.

Generally, the amount of the isocyanate component may vary based on the actual requirement of the synthetic leather article. For example, as one illustrative embodiment, the content of the isocyanate component can be from about 101 mol % to about 300 mol %, preferably from about 110 mol % to about 280 mol %, more preferably from about 150 mol % to about 250 mol %, more preferably from about 170 mol % to 240 mol %, more preferably from about 180 mol % to 230 mol %, more preferably from 190 mol % to 230 mol %, based on the total molar content of the isocyanate-reactive component (B) and the hydroxy-terminated siloxane compound (C).

The Isocyanate-Reactive Component

In various embodiments of the present disclosure, the isocyanate-reactive component comprises one or more polyols selected from the group consisting of aliphatic polyhydric alcohols comprising at least two hydroxy groups, cycloaliphatic or aromatic polyhydric alcohols comprising at least two hydroxy groups, araliphatic polyhydric alcohols comprising at least two hydroxy groups, polyether polyol, polyester polyol and mixture thereof. Preferably, the polyol is selected from the group consisting of C₂-C₁₆ aliphatic polyhydric alcohols comprising at least two hydroxy groups, C₆-C₁₅ cycloaliphatic or aromatic polyhydric alcohols comprising at least two hydroxy groups, C₇-C₁₅ araliphatic polyhydric alcohols comprising at least two hydroxy groups, polyester polyols having a molecular weight from 100 to 5,000, polyether polyols having a molecular weight from 1,500 to 12,000, and combinations thereof. According to a preferable embodiment, the polyol comprises a polyester polyols.

In a preferable embodiment, the isocyanate-reactive component comprises a mixture of two or more different polyols, such as a mixture of two or more polyether polyols, a mixture of two or more polyester polyols, a mixture of at least one polyether polyols with at least one polyester polyols, or a mixture of a polyester polyol and a monomeric polyol.

In a preferable embodiment, the isocyanate-reactive component is a polyester polyol having a molecular weight from 500 to 5,000, preferably from 1000 to 3,000 g/mol so as to achieve good film formability and elasticity of the PUD top film. The polyester polyol is typically obtained by reacting polyfunctional alcohols having from 2 to 12 carbon atoms, preferably from 2 to 6 carbon atoms, with polyfunctional carboxylic acids having from 2 to 12 carbon atoms, preferably 2 to 6 carbon atoms, or anhydrides/esters thereof. Typical polyfunctional alcohols for preparing the polyester polyol are preferably diols or triols and include ethylene glycol, propylene glycol, butylene glycol, pentylene glycol or hexylene glycol. Typical polyfunctional carboxylic acids can be aliphatic, cycloaliphatic, araliphatic, aromatic or heterocyclic and may be substituted, for example with halogen atoms, and/or may be saturated or unsaturated. Preferably, the polyfunctional carboxylic acids are selected from the group consisting of suberic acid, azelaic acid, phthalic acid, isophthalic acid, phthalic anhydride, tetrahydrophthalic anhydride, hexahydrophthalic anhydride, tetrachlorophthalic anhydride, endomethylene-tetrahydro-phthalic anhydride, glutaric anhydride, alkenylsuccinic acid, maleic acid, maleic anhydride, fumaric acid, dimeric fatty acids. Preference is given to dicarboxylic acids represented the general formula HOOC—(CH₂)_{y}—COOH, where y is an integer from 1 to 20, preferably an even number from 2 to 20. The polyester polyol is preferably terminated with at least two hydroxyl groups. In a preferable embodiment, the polyester polyol has a hydroxyl functionality of 2 to 10, preferably from 2 to 6. In another embodiment, the polyester polyol has a OH number of 80 to 2,000 mgKOH/g, preferably from 150 to 1,000 mgKOH/g, and more preferably from 200 to 500 mgKOH/g. Various molecular weights are contemplated for the polyester polyol. For example, the polyester polyol may have a number average molecular weight of from about 500 g/mol to about 5,000 g/mol, preferably from about 600 g/mol to about 4,000 g/mol, preferably from about 500 g/mol to about 3,000 g/mol, preferably from about 1000 g/mol to about 2,500 g/mol, preferably from about 1200 g/mol to about 2,000 g/mol, and more preferably from about 1,500 g/mol to about 1,800 g/mol.

Alternatively, the polyester polyol includes lactone-based polyesterdiols, which are homopolymers or copolymers of lactones, preferably terminal hydroxyl-functional addition products of lactones with suitable difunctional initiator molecules. Preferred lactones are derived from compounds represented by the general formula HO—(CH₂)_{z}—COOH, where z is an integer from 1 to 20 and one hydrogen atom of a methylene unit may also be replaced by a C₁ to C₄ alkyl radical. Exemplary lactone-based polyesterdiols include $-caprolactone, (3-propiolactone, y-butyrolactone, methyl-$-caprolactone or mixtures thereof.

In another preferable embodiment, the isocyanate-reactive component is a polyether polyol having a functionality (average number of isocyanate-reactive groups, particularly, hydroxyl group, in a polyol molecule) of 1.0 to 3.0 and a weight average molecular weight (Mw) of 1,500 to 12,000 g/mol, preferably from 2,000 to 8,000 g/mol, more preferably from 2,000 to 6,000 g/mol. The polyether polyols is generally prepared by polymerization of one or more alkylene oxides selected from propylene oxide (PO), ethylene oxide (EO), butylene oxide, tetrahydrofuran and mixtures thereof, with proper starter molecules in the presence of catalyst. Typical starter molecules include compounds having at least 2, preferably from 4 to 8 hydroxyl groups or having two or more primary amine groups in the molecule. Suitable starter molecules are for example selected from the group comprising aniline, EDA, TDA, MDA and PMDA, more preferably from the group comprising TDA and PMDA, an most preferably TDA. When TDA is used, all isomers can be used alone or in any desired mixtures. For example, 2,4-TDA, 2,6-TDA, mixtures of 2,4-TDA and 2,6-TDA, 2,3-TDA, 3,4-TDA, mixtures of 3,4-TDA and 2,3-TDA, and also mixtures of all the above isomers can be used. By way of starter molecules having at least 2 and preferably from 2 to 8 hydroxyl groups in the molecule it is preferable to use trimethylolpropane, glycerol, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Catalyst for the preparation of polyether polyols may include alkaline catalysts, such as potassium hydroxide, for anionic polymerization or Lewis acid catalysts, such as boron trifluoride, for cationic polymerization. Suitable polymerization catalysts may include potassium hydroxide, cesium hydroxide, boron trifluoride, or a double cyanide complex (DMC) catalyst such as zinc hexacyanocobaltate or quaternary phosphazenium compound. In a preferable embodiment of the present disclosure, the polyether polyol includes (methoxy) polyethylene glycol (MPEG), polyethylene glycol (PEG), poly(propylene glycol) or copolymer of ethylene epoxide and propylene epoxide with primary hydroxyl ended group and secondary hydroxyl ended group.

In general, the content of the isocyanate-reactive component used herein may range from about 50 mol % to about 98 mol %, preferably from about 60 mol % to about 97 mol %, more preferably from about 70 mol % to about 96 mol %, more preferably from about 80 mol % to about 96 mol %, more preferably from about 85 mol % to about 95 mol %, based on the total molar content of the isocyanate-reactive component (B) and the hydroxy-terminated siloxane compound (C).

In the context of the present disclosure, the other compounds comprising functional groups which can react with the isocyanate group, such as the hydroxy-terminated siloxane compound and the chain extender, are not within the definition of the so-called “isocyanate-reactive component”. The hydroxy-terminated siloxane compound and the chain extender can be clearly distinguished from the isocyanate-reactive component by the molecular structure or the time point at which they are added. In particular, the hydroxy-terminated siloxane compound represented by Formula I shall be excluded from the scope of the isocyanate-reactive component. Besides, the compounds which can be used for the chain extender may also comprises at least two isocyanate-reactive groups as stated above, but the chain extender is added in to the reaction system at a later stage in which the main chain of the PU has already formed.

Hydroxy-Terminated Siloxane Compound

The hydroxy-terminated siloxane compound is a compound comprising a block main chain consisting of a) silicon-oxygen unit, b) alkylene oxide unit, and optional c) alkylene unit or is a compound comprising a block main chain consisting of a) silicon-oxygen unit, and b) alkylene unit. The main chain of said hydroxy-terminated siloxane compound is terminated with hydroxyl groups on both ends. According to one embodiment of the present disclosure, the terminal hydroxyl groups can be attached to the alkylene unit, when present, or can be attached to the alkylene oxide unit, when present. The siloxane compound of the present disclosure can be considered as a siloxane (e.g. polydimethylsiloxane, PDMS) modified with the alkylene oxide unit, the terminal hydroxyl groups and the optional alkylene unit or be considered as a siloxane (e.g. polydimethylsiloxane, PDMS) modified with the terminal hydroxyl groups and the alkylene unit. Without being limited to any particular theory, it was found that the inclusion of the alkylene oxide unit in the main chain is vital for the improvement of stickiness. Without being limited to any particular theory, the terminal hydroxyl groups may react with the isocyanate group in the isocyanate component to incorporate the chain segment of the siloxane compound in the polyurethane back bone chain, thus significantly improving the anti-stickiness of the resultant PU skin film. According to one embodiment of the present disclosure, the hydroxy-terminated siloxane compound can be considered as a block prepolymer in which the relation positions of the polysiloxane segment, the alkylene segment and the alkylene oxide segment may vary, as long as the two ends of the prepolymer main chain are terminated with hydroxy group.

According to embodiments of the present disclosure, the molecular structure of the hydroxy-terminated siloxane compound may be represented by Formula I:

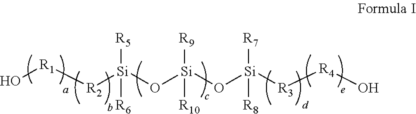

wherein each of R₁ and R₄ independently represents a methylene optionally substituted with one or two substituents selected from the group consisting of C₁-C₅ alkyl, C₁-C₅ alkoxy, C₆-C₁₂ aryl, C₆-C₁₂ aryloxy and halogen; each of R₂ and R₃ independently represents a C₁-C₆ alkylene oxide group optionally substituted with one or more substituents selected from the group consisting of C₁-C₅ alkyl, C₁-C₅ alkoxy, C₆-C₁₂ aryl, C₆-C₁₂ aryloxy and halogen; each of R₅, R₆, R₇, R₈, R₉ and R₁₀ independently represents a C₁-C₅ alkyl optionally substituted with one or more substituents selected from the group consisting of C₁-C₅ alkyl, C₁-C₅ alkoxy, C₆-C₁₂ aryl, C₆-C₁₂ aryloxy and halogen;

wherein each of a and e is independently an integer of 0 to 30, i.e. 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30; preferably an integer of 2 to 20, i.e. 2, 3, 4, 5, 6, 7, 8, 9, 10, 11, 12, 13, 14, 15, 16, 17, 18, 19, 20; more preferably an integer of 3 to 18, i.e. 3, 4, 5, 6, 7, 8, 9, 10, 11, 12, 13, 14, 15, 16, 17, 18; more preferably an integer of 5 to 10, i.e. 5, 6, 7, 8, 9, 10; each of b and d is independently an integer of 5 to 30, i.e. 5, 6, 7, 8, 9, 10, 11, 12, 13, 14, 15, 16, 17, 18, 19, 20, 21, 22, 23, 24, 25, 26, 27, 28, 29, 30, or an integer of 7 to 25, i.e. 7, 8, 9, 10, 11, 12, 13, 14, 15, 16, 17, 18, 19, 20, 21, 22, 23, 24, 25, or an integer of 9 to 20 i.e. 9, 10, 11, 12, 13, 14, 15, 16, 17, 18, 19, 20, or an integer of 12 to 12; and c is an integer of 3 to 100, i.e. 3, 4, 5, 6, 7, 8, 9, 10, 11, 12, 13, . . . 98, 99, 100, or an integer of 5 to 90, i.e. 5, 6, 7, 8, 9, 10, 11, 12, 13, . . . 88, 89, 90, or an integer of 7 to 80, i.e. 7, 8, 9, 10, 11, 12, 13, . . . 78, 79, 80, or an integer of 9 to 70, i.e. 9, 10, 11, 12, 13, . . . 68, 69, 70, or an integer of 10 to 60, i.e. 10, 11, 12, 13, . . . 58, 59, 60, or an integer of 15 to 50, i.e. 15, 16, 17, 18, . . . 48, 49, 50, or an integer of 20 to 40, i.e. 20, 21, 22, 23, . . . , 38, 39, 40, or an integer of 30 to 35, i.e. 30, 31, 32, 33, 34, 35.

or wherein each of a and e is independently an integer of 1 to 30, i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30; preferably an integer of 2 to 20, i.e. 2, 3, 4, 5, 6, 7, 8, 9, 10, 11, 12, 13, 14, 15, 16, 17, 18, 19, 20; more preferably an integer of 3 to 18, i.e. 3, 4, 5, 6, 7, 8, 9, 10, 11, 12, 13, 14, 15, 16, 17, 18; more preferably an integer of 5 to 10, i.e. 5, 6, 7, 8, 9, 10; each of b and d is independently an integer of 0; and c is an integer of 3 to 100, i.e. 3, 4, 5, 6, 7, 8, 9, 10, 11, 12, 13, . . . 98, 99, 100, or an integer of 5 to 90, i.e. 5, 6, 7, 8, 9, 10, 11, 12, 13, . . . 88, 89, 90, or an integer of 7 to 80, i.e. 7, 8, 9, 10, 11, 12, 13, . . . 78, 79, 80, or an integer of 9 to 70, i.e. 9, 10, 11, 12, 13, . . . 68, 69, 70, or an integer of 10 to 60, i.e. 10, 11, 12, 13, . . . 58, 59, 60, or an integer of 15 to 50, i.e. 15, 16, 17, 18, . . . 48, 49, 50, or an integer of 20 to 40, i.e. 20, 21, 22, 23, . . . , 38, 39, 40, or an integer of 30 to 35, i.e. 30, 31, 32, 33, 34, 35.

According to an embodiment of the present disclosure, the hydroxy-terminated siloxane compound has a structure presented by Formula II:

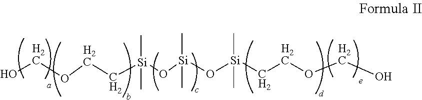

wherein a, b, c, d and e are as described above.

According to an embodiment of the present disclosure, the hydroxy-terminated siloxane compound represented by Formula II:

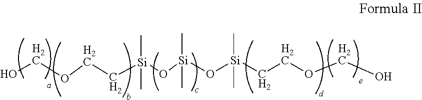

wherein each of a and e is independently an integer of 5 to 10; each of b and d is independently an integer of 5 to 7; and c is an integer of 20 to 40.

According to an embodiment of the present disclosure, the hydroxy-terminated siloxane compound represented by Formula II:

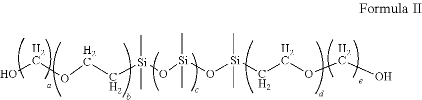

wherein each of a and e is independently an integer of 1 to 30; each of b and d is 0, and c is an integer of 3 to 100.

According to an embodiment of the present disclosure, the hydroxy-terminated siloxane compound represented by Formula II:

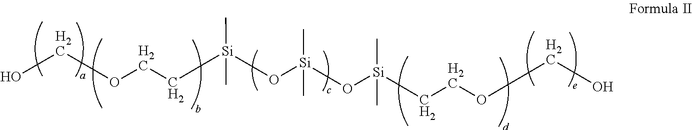

wherein a, b, c, d and e are as described above and wherein the hydroxy-terminated siloxane compound has an EO content based on weight of less than 40%, more preferably less than 35%.

According to an embodiment of the present disclosure, the hydroxy-terminated siloxane compound represented by Formula II:

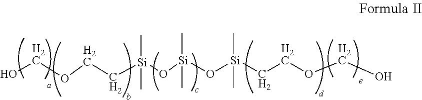

wherein a, b, c, d and e are as described above and wherein the hydroxy-terminated siloxane compound has an EO content based on weight of less than 30%, more preferably less than 28%. In general, the content of the hydroxy-terminated siloxane compound used herein is from 2 mol % to 50 mol %, or from 3 mol % to 40 mol %, or from 4 mol % to 30 mol %, or from 4 mol % to 20 mol %, or from 4 mol % to 15 mol %, or from 5 mol % to 13 mol %, based on the total molar content of the isocyanate-reactive component (B) and the hydroxy-terminated siloxane compound (C).

It's noted that the hydroxy-terminated siloxane compound can be directly mixed with the isocyanate component and the isocyanate-reactive component. Alternatively, the hydroxy-terminated siloxane compound may be combined with the isocyanate-reactive component and then react with the isocyanate component.

Catalyst

Catalyst may include any substance that can promote the reaction between the isocyanate group and the isocyanate-reactive group. Without being limited to theory, the catalysts can include, for example, glycine salts; tertiary amines; tertiary phosphines, such as trialkylphosphines and dialkylbenzylphosphines; morpholine derivatives; piperazine derivatives; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride and stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt; or mixtures thereof.

Tertiary amine catalysts include organic compounds that contain at least one tertiary nitrogen atom and are capable of catalyzing the hydroxyl/isocyanate reaction. The tertiary amine, morpholine derivative and piperazine derivative catalysts can include, by way of example and not limitation, triethylenediamine, tetramethylethylenediamine, pentamethyl-diethylene triamine, bis(2-dimethylaminoethyl)ether, triethylamine, tripropylamine, tributyl-amine, triamylamine, pyridine, quinoline, dimethylpiperazine, piperazine, N-ethylmorpholine, 2-methylpropanediamine, methyltriethylenediamine, 2,4,6-tridimethylamino-methyl)phenol, N,N′,N″-tris(dimethyl amino-propyl)sym-hexahydro triazine, or mixtures thereof.

In general, the content of the catalyst used herein is larger than zero and is at most 1.0 wt %, preferably at most 0.5 wt %, more preferably at most 0.05 wt %, based on the total weight of the isocyanate component (A), the isocyanate-reactive component (B) and the hydroxy-terminated siloxane compound (C). It can be seen that the content of the catalyst is calculated as an additional amount while taking the total amount of the isocyanate component (A), the isocyanate-reactive component (B) and the hydroxy-terminated siloxane compound (C) as 100 wt %.

Emulsifier

According to an embodiment of the disclosure, the emulsifier (E) comprises at least one ionic hydrophilic groups or potentially ionic hydrophilic group and at least two isocyanate-reactive groups, wherein the isocyanate-reactive groups, such as hydroxyl, amine and mercapto group, may react with the isocyanate group to introduce a chain segment having ionic hydrophilic pendent groups or potentially ionic hydrophilic pendent groups in the polyurethane-siloxane main chain of the resultant PU particles. The ionic hydrophilic pendent groups or potentially ionic hydrophilic pendent groups impart the resultant polyurethane particles with improved self-dispersibility and stability in the PUD. The (potentially) ionic hydrophilic groups react with the isocyanates components or the isocyanate-reactive components at a significantly slower rate than that of the isocyanate groups or isocyanate-reactive groups contained in the emulsifier.

In an embodiment of the present disclosure, the (potentially) ionic hydrophilic groups comprise anionic groups such as sulfonate, carboxylate and phosphate in the form of their alkali metal or ammonium salts and also cationic groups such as ammonium groups, especially protonated tertiary amino groups or quaternary ammonium groups. Potentially ionic hydrophilic groups comprise those which can be converted by simple neutralization, hydrolysis or quaternization reactions into the above mentioned ionic hydrophilic groups, for example carboxylic acid groups, anhydride groups or tertiary amino groups.

In a preferable embodiment of the present disclosure, the (potentially) cationic emulsifiers comprise copolymerizable monomers having tertiary amino groups, for example: tris(hydroxyalkyl)amines, N,N′-bis(hydroxyalkyl)-alkylamines, N-hydroxyalkyldialkylamines, tris(aminoalkyl)amines, N,N′-bis(aminoalkyl)alkylamines, N-aminoalkyldialkylamines, wherein the alkyl radicals and alkanediyl units of these tertiary amines independently comprise from 1 to 6 carbon atoms. These tertiary amines are converted into the ammonium salts either with acids, preferably strong mineral acids such as phosphoric acid, sulfuric acid, hydrohalic acids or strong organic acids or by reaction with suitable quaternizing agents such as C₁ to C₆ alkyl halides or benzyl halides, for example bromides or chlorides.

In a preferable embodiment of the present disclosure, the emulsifiers having (potentially) anionic groups include aliphatic, cycloaliphatic, araliphatic or aromatic carboxylic acids, carbonic acids and sulfonic acids which bear at least one alcoholic hydroxyl group or at least one primary or secondary amino group. Preference is given to dihydroxyalkylcarboxylic acids having from 3 to 10 carbon atoms, such as dihydroxymethyl propionic acid (DIPA), dimethylolbutanoic acid (DMBA), dihydroxysulfonic acids, dihydroxyphosphonic acids such as 2,3-dihydroxypropanephosphonic acid. If emulsifiers having potentially ionic groups are used, they may be converted into the ionic form before, during, but preferably after the isocyanate addition polymerization. The sulfonate or carboxylate groups are particularly preferably present in the form of their salts with an alkali metal ion or an ammonium ion as counterion.

According to an embodiment of the present disclosure, the content of the emulsifier (E) is from 0.01 wt % to 10 wt %, or from 0.05 wt % to 8 wt %, from 0.1 wt % to 7 wt %, or from 0.2 wt % to 6 wt %, or from 0.5 wt % to 5 wt %, or from 1 wt % to 5 wt %, or from 2 wt % to 5 wt %, or from 3 wt % to 5 wt %, or from 4 wt % to 5 wt %, based on the total weight of the isocyanate component (A), the isocyanate-reactive component (B) and the hydroxy-terminated siloxane compound (C). It can be seen that the content of the chain extender is calculated as an additional amount while taking the total amount of the isocyanate component (A), the isocyanate-reactive component (B) and the hydroxy-terminated siloxane compound (C) as 100 wt %.

Chain Extender

According to one embodiment of the present disclosure, the chain extender may be a diamine or an amine compound having another isocyanate reactive group, but is preferably selected from the group consisting of: an aminated polyether diol; piperazine; aminoethylethanolamine; C₂-C₁₆ aliphatic polyamine comprising at least two amine groups, e.g., ethylenediamine; C₄-C₁₅ cycloaliphatic or aromatic polyamine comprising at least two amine groups, such as cyclohexanediamine and p-xylenediamine; C₇-C₁₅ araliphatic polyamine comprising at least two amine groups; aminated C₂-C₈ alcohol, e.g., ethanolamine; and mixtures thereof. According to a preferable embodiment, the chain extender is a polyamine having a functionality of 2 and comprising primary amine group or secondary amine group. Preferably, the amine chain extender is dissolved in the water used to make the PU dispersion.

According to an embodiment of the present disclosure, the content of the chain extender is from 0.01 wt % to 10 wt %, or from 0.05 wt % to 8 wt %, from 0.1 wt % to 7 wt %, or from 0.2 wt % to 6 wt %, or from 0.5 wt % to 5 wt %, or from 1 wt % to 3 wt %, based on the total weight of the isocyanate component (A), the isocyanate-reactive component (B) and the hydroxy-terminated siloxane compound (C). It can be seen that the content of the chain extender is calculated as an additional amount while taking the total amount of the isocyanate component (A), the isocyanate-reactive component (B) and the hydroxy-terminated siloxane compound (C) as 100 wt %.

The Waterborne Polyurethane Dispersion

According to an embodiment of the present application, the waterborne polyurethane dispersion is prepared by a three-stage reaction.

In the first stage, the isocyanate groups in the isocyanate component (A) reacts with the isocyanate-reactive groups in the isocyanate-reactive component (B) and the terminal hydroxy groups in the hydroxy-terminated siloxane compound (C) in the presence of the catalyst (D) to form the first prepolymerized intermediates. Without being limited to any particular theory, the first prepolymerized intermediates include the mixture of a reaction product I of the isocyanate component (A) and the isocyanate-reactive component (B) and a reaction product II of the isocyanate component (A) and the hydroxy-terminated siloxane compound (C). Since the isocyanate component (A) is used at a stoichiometrically excessive amount with relative to the combined amount of the isocyanate-reactive groups in component (B) and the terminal hydroxyl group in component (C), both of the above indicated reaction products I and II are terminated with free NCO groups.

In the second stage, an emulsifier is added into the first prepolymerized intermediates and reacts with the reaction products I and II to form a second prepolymerized intermediate comprising the polymeric segments derived from the isocyanate component (A), the isocyanate-reactive component (B) and the hydroxy-terminated siloxane compound (C), and residual moiety of the emulsifier. As stated above, the emulsifier (E) comprises at least one ionic hydrophilic groups or potentially ionic hydrophilic group and at least two isocyanate-reactive groups, wherein the (potentially) ionic hydrophilic groups react with the isocyanates components or the isocyanate-reactive components at a significantly slower rate than that of the isocyanate groups or isocyanate-reactive groups contained in the emulsifier. In the reactions of the second stage, the two isocyanate-reactive groups in the emulsifier reacts with the terminal free NCO groups in the reaction products I and II so as to connect the chain segments of the reaction products I and II together and introduce the (potentially) ionic hydrophilic dependent groups in the main chain at the same time.

In the third stage, the second prepolymerized intermediate reacts with a chain extender under vigorous stirring to form the PUD. According to an embodiment of the present disclosure, the second prepolymerized intermediate comprises anionic dependent group and a neutralization agent is added to neutralize the anionic dependent group before the addition of the chain extender. The neutralization agent may include any alkaline substances that can neutralize the anionic dependent group without influencing the formation of the polyurethane. According to an embodiment of the present disclosure, the neutralization agent is an amine, such as triethylamine.

The waterborne polyurethane dispersion comprises polyurethane particles dispersed in water. The waterborne polyurethane dispersion may be heated and dried to form a skin film exhibiting superior improved anti-stickiness performance while maintaining good PUD film mechanical properties.

The waterborne polyurethane dispersion may have any suitable solids loading of polyurethane particles, but the solids loading is generally between about 1% to about 70% solids by weight of the total dispersion weight, preferably at least about 2%, more preferably at least about 4%, more preferably at least about 6%, more preferably at least about 15%, more preferably at least about 25%, more preferably at least about 35%, most preferably at least about 40%, to at most about 70%, preferably at most 68%, more preferably at most about 65%, more preferably at most about 60% and most preferably at most about 50% by weight.

The waterborne polyurethane dispersion may also contain a rheological modifier such as thickeners that enhance the dispersability and stability of the dispersion. Any suitable rheological modifier may be used such as those known in the art. Preferably, the rheological modifier is one that does not cause the dispersion to become unstable. More preferably, the rheological modifier is a water soluble thickener that is not ionized. Examples of useful rheological modifiers include methyl cellulose ethers, alkali swellable thickeners (e.g., sodium or ammonium neutralized acrylic acid polymers), hydrophobically modified alkali swellable thickeners (e.g., hydrophobically modified acrylic acid copolymers) and associative thickeners (e.g., hydrophobically modified ethylene-oxide-based urethane block copolymers). Preferably the rheological modifier is a methylcellulose ether. The amount of thickener is from at least about 0.2% to about 5% by weight of the total weight of the waterborne polyurethane dispersion, preferably from about 0.5% to about 2% by weight.

Generally, the waterborne polyurethane dispersion has a viscosity from at least about 10 cp to at most about 10,000 cp, preferably, from at least about 20 cp to at most about 5000 cp, more preferably, from at least about 30 cp to at most about 3000 cp.

In an embodiment of the present disclosure, the dispersion of the PU particles in the waterborne polyurethane dispersion can be promoted by surfactant and high shear stirring action, wherein the shear force and stirring speed can be properly adjusted based on specific requirement.

According to one embodiment of the present disclosure, the waterborne polyurethane dispersion may further comprise one or more pigment, dyes and/or colorant, all of which are generally termed as “color masterbatch” in the present disclosure. For example, the color masterbatch may be added so as to impart a transparent or translucent film with a desired color. Examples of pigments dyes and/or colorants may include iron oxides, titanium oxide, carbon black and mixtures thereof. The amount of the pigment, dyes and/or colorant may be 0.1% to 15%, preferably 0.5-10%, more preferably 1% to 5% by weight, based on the total weight of the waterborne polyurethane dispersion. Suitable commercially available black pigments useful in the present invention may include for example EUDERM™ black B-N carbon black dispersion available from Lanxess Deutschland GmbH.

The Laminated Synthetic Leather Article

FIG. 1 is a schematic illustration of a cross-section of one embodiment of the synthetic leather article described herein. In one embodiment of the present disclosure, the synthetic leather article comprises, from top to bottom, a top skin film formed by the waterborne polyurethane dispersion, a 2K PU foam base layer, and a backing substrate (e.g. a textile fabric cloth). Please note that the leather article is not necessarily shown in actual proportion, and the dimensions of one or more layers may be exaggerated so as to clearly show the configuration thereof.

The 2K PU foam used in the present disclosure is preferably a non-solvent PU foam and comprises a continuous PU matrix that defines a plurality of pores and/or cells therein. As disclosed herein, the terms “solvent free”, “solventless” or “non-solvent”, can be used interchangeably for describing the PU foam or any other dispersion, mixture, etc., and shall be interpreted that the mixture of all the raw materials used for preparing the PU foam or PU dispersion comprise less than 3% by weight, preferably less than 2% by weight, preferably less than 1% by weight, more preferably less than 0.5% by weight, more preferably less than 0.2% by weight, more preferably less than 0.1% by weight, more preferably less than 100 ppm by weight, more preferably less than 50 ppm by weight, more preferably less than 10 ppm by weight, more preferably less than 1 ppm by weight of any organic or inorganic solvents, based on the total weight of the mixture of raw materials. As disclosed herein, the term “solvent” refers to organic and inorganic liquids whose function is solely dissolving one or more solid, liquid or gaseous materials without incurring any chemical reaction. In other words, although some organic compounds, e.g. ethylene glycol and propylene glycol, and water, which are generally considered as “solvent” in the polymerization technology, are used in the preparation of the 2K PU foam, none of them belongs to “solvent” since they mainly function as isocyanate-reactive functional substance, chain extending agent or foaming agent, etc. by incurring chemical reactions.

According to one embodiment of the present disclosure, the 2K PU foam layer has a thickness in the range from 0.01 m to 2,000 m, preferably in the range from 0.05 m to 1,000 μm, more preferably in the range from 0.1 m to 750 m and more preferably in the range from 0.2 μm to 600 μm.

According to one embodiment of the present disclosure, the 2K foamed polyurethane in the polyurethane foam layer is prepared with a solvent-free polyurethane system comprising (i) one or more second isocyanate components, (ii) one or more second isocyanate-reactive components, (iii) one or more foaming agent, second catalyst and any other additives. The second isocyanate component (i) includes one or more polyisocyanates and/or isocyanate prepolymers which are used for the isocyanate component (A). The second isocyanate-reactive components (ii) comprise compounds having two or more isocyanate-reactive groups selected from OH groups, SH groups, NH groups, NH₂ groups and carbon-acid groups, for example P-diketo groups. According to one embodiment of the present application, the isocyanate-reactive components (ii) comprise those used for the isocyanate-reactive component (B). In one preferred embodiment of the present disclosure, the second isocyanate components (i) and second the isocyanate-reactive components (ii) react with each other in the presence of a foaming/blowing agent, and the foaming agent is used in combination with the isocyanate-reactive components. Useful foaming agents include commonly known chemically or physically reactive compounds. Physical blowing agents may be selected from one or more of a group consisting of carbon dioxide, nitrogen, noble gases, (cyclo)aliphatic hydrocarbons having from 4 to 8 carbon atoms, dialkyl ethers, esters, ketones, acetal and fluoroalkanes having from 1 to 8 carbon atoms. The chemically reactive blowing agent preferably comprises water, which is preferably contained as a constituent of the blend with the isocyanate-reactive components (ii). The amount of the foaming agent is in the range from 0.05 to 10%, preferably in the range from 0.1 to 5%, more preferably from 0.1 to 2%, and most preferably from 0.1 to 0.5% by weight, based on the overall weight of all the raw materials used for preparing the 2k PU foam layer. The 2K PU layer typically has a density of 0.3 to 1.1 kg/liter and preferably has a density of 0.4 to 0.9 kg/liter.

In an embodiment of the present disclosure, the second isocyanate components (i) reacts with the second isocyanate-reactive components (ii) in the presence of a catalyst selected from organotin compounds, such as tin diacetate, tin dioctoate, dibutyltin dilaurate, and/or strongly basic amines such as diazabicyclooctane, triethylamine, triethylenediamine or bis(N,N-dimethylaminoethyl) ether in an amount from 0.01% to 5% by weight, preferably from 0.05% to 4% by weight, more preferably from 0.05% to 3% by weight, based on the overall weight of all the raw materials used for preparing the 2K PU foam layer.

In an embodiment of the present disclosure, the categories and molar contents of the second isocyanate components (i) and the second isocyanate-reactive components (Bii) are particularly selected so that the overall equivalence ratio of NCO groups to NCO-reactive hydrogen atoms (e.g. hydrogen atom in the hydroxyl group) is in the range from 0.9:1 to 1.8:1, preferably from 0.92:1 to 1.6:1, preferably in the range from 0.95:1 to 1.5:1, and more preferably in the range from 1:1 to 1.45:1, more preferably in the range from 1.05:1 to 1.4:1, and more preferably in the range from 1.10:1 to 1.35:1.

Release Layer

Suitable release layers are typically known in the prior art as “release paper”. Examples of suitable release layers include foils of metal, plastic or paper. In one preferred embodiment of the present disclosure, the release layer is a paper layer optionally coated with a plastic membrane. Preferably, the paper layer disclosed herein is coated with a polyolefin, more preferably polypropylene. Alternatively, the paper layer is preferably coated with silicone. In an alternative embodiment, the release layer used herein is a PET layer optionally coated with plastic membrane. Preferably, the PET layer can be is coated with a polyolefin, more preferably polypropylene. Alternatively, the PET layer is preferably coated with silicone. Examples of suitable release layers are commercially available. The release layers used in the present disclosure may have a flat, embossed or patterned surface so that corresponding or complementary surface profile can be formed on the outermost surface of the synthetic leather article. Preferably, the release layer is textured in the mode of leather grain so as to impart the synthetic leather article with good haptic property comparable with that of high grade natural leather. The release layer generally has a thickness of 0.001 mm to 10 mm, preferably from 0.01 mm to 5 mm, and more preferably from 0.1 mm to 2 mm.

The material and the thickness of the release layer can be properly adjusted, as long as the release layer is able to endure the chemical reaction, mechanical processing and thermal treatments experienced during the manufacturing procedures and can be readily peeled from the resultant synthetic leather without bringing about the delamination between the skin film and the 2k PU foam base layer.

Auxiliary Agents and Additives

The PU skin film and the 2K PU foam base layer may independently and optionally comprise any additional auxiliary agents and/or additives for specific purposes.

In one embodiment of the present disclosure, one or more of the auxiliary agents and/or additives may be selected from the group consisting of fillers, cell regulators, release agents, colorants/pigments, surface-active compounds, hand-feeling agents, dullers, thickeners, crosslinkers and stabilizers.

Examples of suitable fillers comprise glass fibers, mineral fibers, natural fibers, such as flax, jute or sisal for example, glass flakes, silicates such as mica or glimmer, salts, such as calcium carbonate, chalk or gypsum. The fillers are typically used in an amount from 0.5% to 60% by weight, preferably from 3% to 30% by weight, and more preferably from 3% to 10% by weight, based on the overall dry weight of the skin film or the 2K PU foam base layer.

Backing Substrate

In an embodiment of the present disclosure, the backing substrate has a thickness of in the range from 0.01 mm to 50 mm, preferably in the range from 0.05 mm to 10 mm and more particularly in the range from 0.1 mm to 5 mm. The backing substrate may comprise one or more selected from the group consisting of fabric, preferably woven or nonwoven fabric, impregnated fabrics, knit fabric, braid fabric or microfiber; foil of metal or plastic, e.g. rubber, PVC or polyamides; and leather, preferably split leather.

The backing substrate can be made of a woven or nonwoven textile. Preferably, the textile is a nonwoven textile. The textile may be made by any suitable method such as those known in the art. The textile may be prepared from any suitable fibrous material. Suitable fibrous materials include, but are not limited to, synthetic fibrous materials and natural or semi synthetic fibrous materials and mixtures or blends thereof. Examples of synthetic fibrous materials include polyesters, polyamides, acrylics, polyolefins, polyvinyl chlorides, polyvinylidene chlorides, polyvinyl alcohols and blends or mixtures thereof. Examples of natural semi-synthetic fibrous materials include cotton, wool and hemp.

Manufacture Technology

The waterborne polyurethane dispersion may be applied by conventional coating technologies such as spraying coating, blade coating, die coating, cast coating, etc.

The skin film can be either partially or completely dried before the application of the next layer. Preferably, the skin film is completely dried so as to minimize the moisture entrapped therein, and then the next layer is applied thereon. In an alternative embodiment of the present application, only part of the moisture is removed from the skin film on the release layer, then the skin film is completely dried together with the 2K PU foam layer applied thereon.

According to one embodiment, the second isocyanate component (i) and the second isocyanate-reactive component (ii) for the 2K non-solvent PU foam are mixed together, applied to the skin film, and pre-cured by being heated in an oven at a temperature of e.g. from 70° C. to 120° C., preferably from 75° C. to 110° C. for a short duration of 10 seconds to 5 minutes, preferably from 30 seconds to 2 minutes, more preferably from 45 to 90 seconds. Then the backing substrate (e.g. a textile fabric) is applied to the pre-cured 2k PU foam layer with the assistance of a pressing roller, followed by being post cured at a higher temperature of e.g. from 100° C. to 160° C., preferably from 110° C. to 150° C. for a longer duration of 3 to 20 minutes, preferably from 3 to 15 minutes, more preferably from 4 to 10 minutes. The above stated two-step curing process aims to ensure high adhesion strength between the pre-cured 2k PU foam and the backing substrate.

According to a preferable embodiment of the present disclosure, the release layer is removed after the 2k PU foam has been fully cured. The release layer can be peeled off via any ordinary technologies.

According to a preferable embodiment of the present disclosure, after the removal of the release layer, a top finishing layer can be applied onto the surface of the synthetic leather (i.e. on the outermost surface of the skin film) and dried to form a protection film layer. The presence of the finishing layer can further increase abrasion resistance of the multilayer synthetic leather. The protection film layer may be formed by using any suitable raw materials and technologies. The finishing layer may optionally comprise additives such as wetting agent, crosslinking agent, binder, matting agent, hand-feel modifier, pigments and/or colorants, thickener or other additives used for the skin film. The synthetic leather disclosed herein can further comprise one or more than one optional additional layer such as a color layer between the skin film and the finishing layer. Other suitable optional additional layers can be selected from a water repellent layer, UV protective layer and tactile (touch/feel) modification layer.

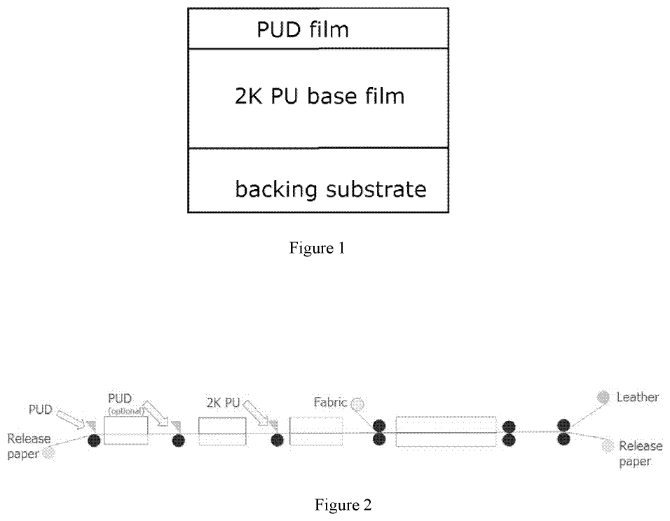

The process of the present invention may be carried out continuously or batchwise. An example of the continuous process is a roll to roll process, and is schematically shown in FIG. 2. A roll of release paper is unwound and transmitted through two or more work station where the PUD of the present application and the 2K PU dispersion are applied in sequence. The PUD of the present application can be applied more than once to achieve a desirable film thickness or composition profile. For example, it is shown in FIG. 2 that a second PUD was applied onto the surface of the film formed by the first PUD. The second PU skin film may have a thickness and composition identical or different from those of the first PU skin film so as to meet actual industrial requirements. Heating or irradiation devices may be arranged after each coating station to promote the drying or curing of the coated layers, and rollers can also be used for enhancing the adhesion strength between the layers. The unwound release layer is generally from 10 to 20,000 meters, from 10 to 15,000 meters and preferably from 20 to 10,000 meters in length and is typically transmitted at a speed in the range from 0.1 to 60 m/min, preferably from 3 to 45m/min, more preferable from 5 to 15m/min. In the end of the continuous technology, the release layer is peeled off and wound up on a spindle. The wound-up release layer may be reused, preferably for at least 2 times.

The fabric backing substrate can be provided in a roll to roll mode, i.e. the backing substrate is provided as a roll, unwound and applied on the surface of the partially cured 2K PU foam, then the 2K PU foam is fully cured and the laminated synthetic leather article can be wound on a spindle and stored/sold as a roll.

In one preferred embodiment, the synthetic leather is oriented by being stretched in one or two directions (i.e. uniaxial or biaxial orientation). The dimension of the oriented synthetic leather may be increased by a factor of 1.1 to 5, preferably by a factor of 1.2 to 2. The oriented synthetic leather exhibits improved breathability.

The multilayer structure synthetic leather disclosed herein can be cut or otherwise shaped so as to have a shape suitable for any desired purpose, such as shoe manufacturing. Depending on the intended application, the synthetic leathers can be further treated or post-treated similarly to natural leathers, for example by brushing, filling, milling or ironing. If desired, the synthetic leathers may (like natural leather) be finished with the customary finishing compositions. This provides further possibilities for controlling their character. The multilayer structure disclosed herein may be used in various applications particularly suitable for use as synthetic leather, for example, footwear, handbags, belts, purses, garments, furniture upholstery, automotive upholstery, and gloves. The multilayer structure is particular suitable for use in automotive applications.

### EXAMPLES

Some embodiments of the invention will now be described in the following Examples, wherein all parts and percentages are by weight unless otherwise specified.

The information of the raw materials used in the examples is listed in the following table 1:

TABLE 1
Raw materials used in the examples

| Components | Grades | Supplier |
|---|---|---|
| Polyester polyol | 7112T | QingDao Xinyutian Chemical |
| isocyanate | IPDI | Evonik |
| ABA type OH terminated siloxane | BY 16-201 | Dow Chemical |
| PDMS % by weight = 74% EO % by | | |
| weight is about 26% | | |
| ABA type OH terminated siloxane | SF 8427 | Dow Chemical |
| PDMS % by weight = 48%; EO % by | | |
| weight is about 52% | | |
| Alkyl type OH terminated siloxane | Di10 | Siltech |
| Dimethylol Propionic Acid (DMPA) | Dimethylol Propionic Acid | Sinopharm Chemical Reagent |
| Ethidene Diamine | Ethidene Diamine | Sinopharm Chemical Reagent |
| Triethylamine | Triethylamine | Sinopharm Chemical Reagent |
| Color master batch | Euderm Black B-N | Lanxess |
| Thickener | RM 825 | Dow Chemical |
| Polyol in 2K PU composite | See Table 2 | Dow Chemical |
| Prepolymer in 2K PU composite | Voralast* GE 143 ISO | Dow Chemical |
| Non-woven fabric | Spunlace, 6-7 mm | Xiaoshan Hangmin |
| Release paper | DE-90 | Ajinomoto |

The 2K non-solvent PU foam is prepared by combining the isocyanate prepolymer (Voralast™ GE 143 ISO) shown in table 1 and the polyol raw materials listed in table 2.

TABLE 2
Polyol raw materials used in 2K PU composite

| | Materials | Content/% | Vendor |
|---|---|---|---|
| Polyol in 2K PU | SPECFLEX NC 701 | 28 | Dow Chemical |
| composite | VORANOL CP 6001 | 46 | Dow Chemical |
| | VORANOL 4240/EP | 18 | Dow Chemical |
| | 1900 | | |
| | Dipropylene glycol | 4 | Dow Chemical |
| | Ethylene glycol | 3 | Dow Chemical |
| | WATER | 0.22 | NA |
| | Dbaco DC-193 | 0.5 | Dow Chemical |
| | Polycat SA2LE | 0.2 | Evonik |
| | Polycat SA-1 | 0.04 | Evonik |
| | Niax C-225 | 0.02 | Evonik |

| Mixing ratio | |
|---|---|
| Above polyol formulation/Voralast* | 100/54 |
| GE 143 ISO | |

In the following Examples, synthetic leather articles comprising a skin film derived from the waterborne polyurethane dispersion and a 2K PU base layer were prepared by the following Steps 1) to 4).

1) Preparation of the Waterborne Polyurethane Dispersion

7112T (25.00 g), IPDI (11.11 g) and OH terminated siloxane (if any) were charged into a 1000 ml three neck flask and mixed under 80° C. for 1 hour, and then 0.2 g of catalyst (DBTDL) was added into the flask to start the reaction. The reaction lasted for two hours to produce the first prepolymerized intermediates. DMPA (1.68 g) was added to the flask and 10 reacted for 2 hours. The first prepolymerized intermediates were cooled to 40° C. and neutralized with TEA (1.26 g) for 30 minutes. Small amount of acetone was added into the flask during the above procedure to keep the viscosity of the reaction system at around 500 cps. The flask was cooled to room temperature, and 93 g of an aqueous solution of EDA (0.83 g) was added to the flask under vigorous stirring to form the PUD. At last, acetone was removed from the PUD by reduced pressure distillation.

Six PU dispersions were prepared by using different formulations as shown in table 3. All of these PUDs have a solid content of 30 wt %.

TABLE 3
the hydroxy-terminated siloxanes used for preparing the PUD

| | hydroxy- | amount of the hydroxy- |
|---|---|---|
| | terminated siloxane | terminated siloxane (gram) |
| PUD A | None | 0 |
| PUD B | SF 8427 | 2.50 |
| PUD C | SF 8427 | 5.00 |
| PUD D | BY 16-201 | 2.50 |
| PUD E | Di-10 | 2.50 |
| PUD F | Di-10 | 1.25 |

2) Preparation of PU Film

22.5 gram of the polyurethane dispersion prepared in step 1) was weighed, transferred into a vacuum oven and degassed for about 10 minutes. Then the degassed PUD was poured into a plastic surface petri dish and stood still over night under the ambient condition. The dish filled with PUD was heated on a heating platform at 40° C. for 24 h and in an air dry oven 60° C. for 24 h. The film was peeled from the dish, dried for another 24 hours and cooled down to room temperature for testing. Six PU films were prepared by using PUD A to PUD F, respectively.

3) Fabrication of Synthetic Leather

The waterborne polyurethane dispersion prepared in step 1) was mixed with color masterbatch and thickener as shown in Table 4 at high speed (1000˜3000 rpm) for several minutes. The formulated PUD was coated on a release paper to a wet film thickness of 150 m. The coated release paper was dried in oven at 60° C. for 10 min and then at 130° C. for 10 min. The release paper with dried PU skin layer was taken out of the oven and cooled down to ambient temperature. The formulated 2K PU composite was coated on the dried PU skin film to a wet film thickness of 300 m. The release paper with the PU skin film and the coated 2K PU composite was transferred into a 85° C. oven and precured for 45 seconds. A backing substrate (textile fabric cloth) was then carefully applied onto the 2K PU foam layer and pressed with a 3.5 kg roller for 2 times. The specimen was put into a 120° C. oven and post-cured for 10 minutes, and then taken out and cooled down.

TABLE 4
The amounts (wt %) of raw materials used in Step 3)

| | Exam- | Exam- | Exam- | Exam- | Exam- | Exam- |
|---|---|---|---|---|---|---|
| Components | ple1 | ple2 | ple 3 | ple 4 | ple 5 | ple 6 |
| PUD A | 93 | | | | | |
| PUD E | | 93 | | | | |
| PUD B | | | 93 | | | |
| PUD C | | | | 93 | | |
| PUD D | | | | | 93 | |
| PUD F | | | | | | 93 |
| Euderm Black | 5 | 5 | 5 | 5 | 5 | 5 |
| B-N | | | | | | |
| RM 825 | 1 | 1 | 1 | 1 | 1 | 1 |

Characterizing the PUD and the Synthetic Leather

(a) The average particle size and the stability (after different time durations) of the PUD A to F were characterized by the technology of Dynamic Light Scattering with a Malvern Instruments ZS90 Particle Size and Zeta Potential Analyzer at 25° C. and the characterization results were summarized in Table 5. It can be seen that all the PUDs have excellent stability.

TABLE 5
Characterization Results of PUD A to F

| | 0 Day | | | | | |
|---|---|---|---|---|---|---|
| | | Polymer | After 30 days | | After 50 days | |
| | Z- | dispersity | Z- | | Z- | |
| | Average | index | Average | | Average | |
| | (d · nm) | (PdI) | (d · nm) | PdI | (d · nm) | PdI |
| PUD A | 32 | 0.235 | 32 | 0.209 | 32 | 0.190 |
| PUD B | 42 | 0.320 | 34 | 0.264 | 34 | 0.255 |
| PUD C | 32 | 0.397 | 34 | 0.307 | 36 | 0.288 |
| PUD D | 99 | 0.534 | 117 | 0.540 | 114 | 0.582 |
| PUD E | 50 | 0.467 | 41 | 0.361 | 40 | 0.323 |
| PUD F | 45.5 | 0.395 | NA | NA | NA | NA |

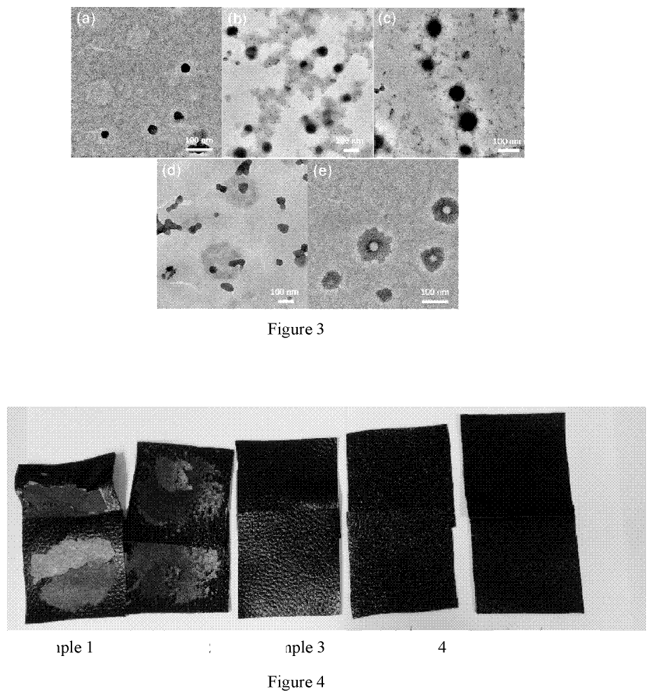

(b) The TEM photomicrographs of PUD A to E are shown in FIG. 3, wherein graphs (a) to (e) correspond to PUD A to E respectively. It can be seen that PUD B to D, which were prepared by using the hydroxy-terminated siloxane compound represented by Formula I, have uniform particle structure, while PUD E, which is prepared by using a hydroxy-terminated siloxane compound without any alkylene oxide segment, comprises particles having a core-shell structure. Without being limited to any particular theory, it is conjectured that the differences in the composition and structure of the PU particles in the PUD E could be the reason for the deteriorated anti-stickiness thereof.

(c) The water contact angles of the PU films prepared by using PUD A to PUD D were measured on a contact angle system (Data physics, OCA20, Germany) at room temperature. A syringe was mounted so that a 3 μl water droplet was dropped through the needle of the syringe onto the surface of the film sample. Photos of the droplet were taken to calculate the contact angle by Sessile Drop Method. Five measurements were made for each sample, and the average value was used for analysis. The measurement results were summarized in Table 6, from which it can be seen that the PU films prepared with PUD B to PUD D exhibit higher water contact angles (i.e. better hydrophobicity) over the PUD film with the control PUD A which is free of the hydroxy-terminated siloxane compound represented by Formula I.

TABLE 6
The water contact angles of PU films prepared with PUD A to PUD D

| | PUD A | PUD B | PUD C | PUD D |
|---|---|---|---|---|
| Water contact | 87.7 | 95.5 | 104.5 | 100.8 |
| angle | | | | |

(d) Performance Properties of Synthetic Leather Article Prepared in Step 3)

The anti-stickiness of the synthetic leather articles prepared in above Step 3) were characterized according to the standard GB/T 8948-2008. In particular, two 90 mm×60 mm samples of the synthetic leather article were pasted together face to face under a pressure of 1 kg and heated in an oven at 85° C. for 3 h. The anti-stickiness was ranked from 1 to 5 according to the degree of stickiness between the two samples during detaching of the two samples at room temperature:

Rank 1: not sticky completely;

Rank 2: can be detached with a little force;

Rank 3: can be detached with a certain force, and the surface is not destroyed;

Rank 4: can be detached with a large force and incomplete damage occurs on the surface; and

Rank 5: cannot be detached.

The COF (Coefficient of Friction) of the synthetic leather articles prepared in above Step 3) were characterized according to the standard GB/T 2726-2005 with a wheel of no. CS10 under a load of 1000g for 1000 cycles. The synthetic leather articles are marked as “PASS” when a result of Grade 4 or higher Color scorecard is obtained.

TABLE 7
The appearance, anti-stickiness and COF of the leather articles.

| | | Example1 | Example2 | Example 3 | Example 4 | Example 5 |
|---|---|---|---|---|---|---|
| | | (Control) | (Control) | (Inventive) | (Inventive) | (Inventive) |
| Leather | Leather | good | good | good | good | good |
| performance | Appearance | | | | | |
| | after curing | | | | | |
| | Anti-stickiness | 5 | 5 | 3 | 3 | 3 |
| | COF | Pass | Pass | Pass | Pass | Pass |

FIG. 4 shows the photographs of the synthetic leathers prepared in Examples 1-2 and Examples 3-5, which clearly shows the superior anti-stickiness of the synthetic leathers prepared with the hydroxy-terminated siloxane compound.

Leather Appearance:

The leather appearance was checked visually, and “good” means smooth and no bubbles.

Wet color fastness of the synthetic leather articles prepared in above Step 3) was characterized according to GB/T20991. Wet white wolf cloth was used to test the surface. When the surface of the wet white wolf cloth showed dark color, the number was counted. More tested number means a better wet color fastness.

TABLE 8
The appearance, wet color fastness and COF of the leather articles.

| | | Example1 | Example2 | Example 3 | Example 4 | Example 5 | Example 6 |
|---|---|---|---|---|---|---|---|
| | | (Control) | (Inventive) | (Control) | (Control) | (Inventive) | (Inventive) |
| Leather | Leather | good | good | good | good | good | good |
| performance | Appearance | | | | | | |
| | after curing | | | | | | |
| | Wet color | 50 | 150 | 50 | 50 | >500 | 100 |
| | fastness | | | | | | |
| | (times) | | | | | | |
| | COF | Pass | Pass | Pass | Pass | Pass | Pass |

The results in Table 8 show that the synthetic leathers prepared in Examples 3-4, which were prepared from PEO-PDMS-PEO with high EO (about 52% based on weight) modified PUD, did not show any improvement of wet color fastness of the skin layer compared with Example 1; while Examples 2 and 5-6, which were prepared from a hydroxyl-terminated siloxane compound without EO units (Example 2 and 6) or a OH terminated siloxane having a low EO content (about 26% based on weight) (Example 5) modified PUD, can significantly improve the wet color fastness of the skin layer compared with Example 1.

1. A waterborne polyurethane dispersion comprising polyurethane particles dispersed in water, wherein the waterborne polyurethane dispersion is derived from:
(A) an isocyanate component comprising one or more compounds having at least two isocyanate groups;
(B) an isocyanate-reactive component comprising one or more compounds having at least two isocyanate-reactive groups;
(C) a hydroxy-terminated siloxane compound represented by Formula I: 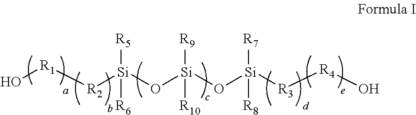
wherein each of R₁ and R₄ independently represents a methylene optionally substituted with one or two substituents selected from the group consisting of C₁-C₅ alkyl, C₁-C₅ alkoxy, C₆-C₁₂ aryl, C₆-C₁₂ aryloxy and halogen;
each of R₂ and R₃ independently represents a C₁-C₆ alkylene oxide group optionally substituted with one or more substituents selected from the group consisting of C₁-C₅ alkyl, C₁-C₅ alkoxy, C₆-C₁₂ aryl, C₆-C₁₂ aryloxy and halogen;
each of R₅, R₆, R₇, R₈, R₉ and R₁₀ independently represents a C₁-C₅ alkyl optionally substituted with one or more substituents selected from the group consisting of C₁-C₅ alkyl, C₁-C₅ alkoxy, C₆-C₁₂ aryl, C₆-C₁₂ aryloxy and halogen;
wherein each of a and e is independently an integer of 0 to 30; each of b and d is independently an integer of 5 to 30; and c is an integer of 3 to 100; or
each of a and e is independently an integer of 1 to 30; each of b and d is independently an integer of 0; and c is an integer of 3 to 100;
(D) a catalyst;
(E) an emulsifier;
(F) a chain extender; and
(G) water.

2. The waterborne polyurethane dispersion according to claim 1, wherein the hydroxy-terminated siloxane compound represented by Formula II: 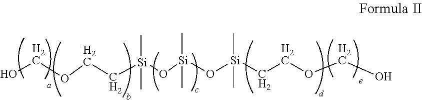
wherein each of a and e is independently an integer of 0 to 30; each of b and d is independently an integer of 5 to 30; and c is an integer of 3 to 100; or
each of a and e is independently an integer of 1 to 30; each of b and d is independently an integer of 0; and c is an integer of 3 to 100.

3. The waterborne polyurethane dispersion according to claim 1, wherein the hydroxy-terminated siloxane compound represented by Formula II: 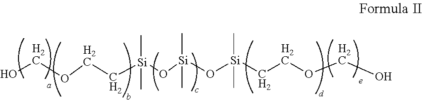
wherein each of a and e is independently an integer of 5 to 10; each of b and d is independently an integer of 5 to 7; and c is an integer of 20 to 40.

4. The waterborne polyurethane dispersion according to claim 1, wherein the hydroxy-terminated siloxane compound represented by Formula II: 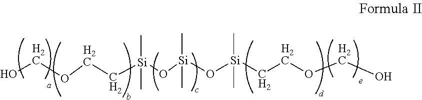
wherein each of a and e is independently an integer of 0 to 30; each of b and d is independently an integer of 5 to 30; and c is an integer of 3 to 100 and wherein the hydroxy-terminated siloxane compound has an EO content based on weight of less than 40%, or less than 30%.

5. The waterborne polyurethane dispersion according to claim 1, wherein the one or more compounds having at least two isocyanate groups are selected from the group consisting of:
a) C₄-C₁₂ aliphatic polyisocyanates comprising at least two isocyanate groups, C₆-C₁₅cycloaliphatic or aromatic polyisocyanates comprising at least two isocyanate groups, C₇-C₁₅ araliphatic polyisocyanates comprising at least two isocyanate groups, and a combination thereof; and
b) an isocyanate prepolymer prepared by reacting one or more polyisocyanates of a) with one or more isocyanate-reactive components selected from the group consisting of C₂-C₁₆ aliphatic polyhydric alcohols comprising at least two hydroxy groups, C₆-C₁₅ cycloaliphatic or aromatic polyhydric alcohols comprising at least two hydroxy groups, C₇-C₁₅ araliphatic polyhydric alcohols comprising at least two hydroxy groups, polyester polyols having a molecular weight from 500 to 5,000, polycarbonate diols having a molecular weight from 200 to 5,000, polyetherdiols having a molecular weight from 200 to 5,000, C₂ to C₁₀ polyamine comprising at least two amino groups, C₂ to C₁₀ polythiol comprising at least two thiol groups, C₂-C₁₀ alkanolamine comprising at least one hydroxyl group and at least one amino groups, and a combination thereof, with the proviso that the isocyanate prepolymer comprises at least two free isocyanate terminal groups.

6. The waterborne polyurethane dispersion according to claim 1, wherein the content of the isocyanate component (A) is from 101 mol % to 300 mol %, based on the total molar content of the isocyanate-reactive component (B) and the hydroxy-terminated siloxane compound (C).

7. The waterborne polyurethane dispersion according to claim 1, wherein the one or more compounds having at least two isocyanate-reactive groups are selected from the group consisting of: C₂-C₁₆ aliphatic polyhydric alcohols comprising at least two hydroxy groups, C₆-C₁₅ cycloaliphatic or aromatic polyhydric alcohols comprising at least two hydroxy groups, C₇-C₁₅ araliphatic polyhydric alcohols comprising at least two hydroxy groups, polyester polyols having a molecular weight from 500 to 5,000, polycarbonate diols having a molecular weight from 200 to 5,000, polyetherdiols having a molecular weight from 200 to 5,000, C₂ to C₁₀ polyamine comprising at least two amino groups, C2 to C10 polythiol comprising at least two thiol groups, C₂-C₁₀ alkanolamine comprising at least one hydroxyl group and at least one amino groups, vegetable oil having at least two hydroxyl groups, and a combination thereof.

8. The waterborne polyurethane dispersion according to claim 1, wherein the content of the isocyanate-reactive component (B) is from 50 mol % to 98 mol %, based on the total molar content of the isocyanate-reactive component (B) and the hydroxy-terminated siloxane compound (C).

9. The waterborne polyurethane dispersion according to claim 1, wherein the content of the hydroxy-terminated siloxane compound (C) is from 2 mol % to 50 mol %, based on the total molar content of the isocyanate-reactive component (B) and the hydroxy-terminated siloxane compound (C).

10. The waterborne polyurethane dispersion according to claim 1, wherein the catalyst (D) is selected from the group consisting of: organotin compound, organic dismuth compound, tertiary amine, morpholine derivative, piperazine derivative, and combination thereof; and
wherein the content of the catalyst (D) is 1.0 wt % or less, based on the total weight of the isocyanate component (A), the isocyanate-reactive component (B) and the hydroxy-terminated siloxane compound (C).

11. The waterborne polyurethane dispersion according to claim 1, wherein the emulsifier (E) comprises 2-12 carbon atoms, at least one ionic hydrophilic groups or potentially ionic hydrophilic group and at least two isocyanate-reactive groups,
wherein the ionic hydrophilic group is selected from the group consisting of sulfonic acid group, sulfonate, carboxy group, carboxylate group, phosphorous-containing acid group, phosphorous-containing acid salt group, protonated tertiary amino group and quaternary ammonium group, wherein the potentially ionic hydrophilic group is able to be converted into the ionic hydrophilic group by a neutralization, hydrolysis or quaternization reactions;
the isocyanate-reactive group contained in the emulsifier is selected from the group consisting of hydroxyl, amine and mercapto group; and
wherein the amount of the emulsifier (E) is from 0.01 wt % to 10 wt %, based on the total weight of the the isocyanate component (A), the isocyanate-reactive component (B) and the hydroxy-terminated siloxane compound (C).

12. The waterborne polyurethane dispersion according to claim 1, wherein the chain extender (F) is selected from the group consisting of: C₂-C₁₆ aliphatic polyamine comprising at least two amine groups, C₄-C₁₅ cycloaliphatic or aromatic polyamine comprising at least two amine groups, C₇-C₁₅ araliphatic polyamine comprising at least two amine groups; and
wherein the content of the chain extender (F) is from 1.0 wt % to 15 wt %, based on the total weight of the the isocyanate component (A), the isocyanate-reactive component (B) and the hydroxy-terminated siloxane compound (C).

13. The waterborne polyurethane dispersion according to claim 1, wherein the waterborne polyurethane dispersion has a solid content of 5 wt % to 50 wt %, based on the total weight of the waterborne polyurethane dispersion; and
the polyurethane particles have a volume average particle size of 20 nm to 5 μm.

14. A method for preparing the waterborne polyurethane dispersion according to claim 1, the method comprising
(i) reacting the isocyanate component (A) with the isocyanate-reactive component (B) and the hydroxy-terminated siloxane compound (C) in the presence of the catalyst (D) to form first prepolymerized intermediates;
(ii) reacting the first prepolymerized intermediates with the emulsifier (E) to form a second prepolymerized intermediate;
(iii) reacting the second prepolymerized intermediate with the chain extender (F) to form the waterborne polyurethane dispersion.

15. The method according to claim 1, wherein the second prepolymerized intermediate formed in step (ii) is neutralized with a neutralization agent before reacting with the chain extender (F).

16. A synthetic leather article, comprising, from top to bottom:
a polyurethane skin film derived from the waterborne polyurethane dispersion according to claim 1;
a base layer derived from a 2k PU composite composition; and
an optional backing substrate, wherein the polyurethane skin film directly contacts with the base layer, and the backing substrate, when present, directly contacts with the base layer.

17. A method for preparing the synthetic leather article according to claim 16, comprising:
a) providing the waterborne polyurethane dispersion according to claim 1;
b) forming the polyurethane skin film with the waterborne polyurethane dispersion;
c) applying the 2k PU composite composition onto one side of the polyurethane skin film to form the base layer; and
d) optionally, applying the backing substrate onto one side of the base layer opposite the polyurethane skin film.
